(19) United States
(12) Patent Application Publication
(10) Pub. No.: US 2019/0034209 A1
(43) Pub. Date: Jan. 31, 2019

(54) BUILDING AND USING BEHAVIOR-BASED APPLICATIONS

(71) Applicant: SAP SE, Walldorf (DE)

(72) Inventors: Slavin Donchev, Mannheim (DE); Markus Latzina, Wiesenbach (DE)

(21) Appl. No.: 15/827,147

(22) Filed: Nov. 30, 2017

Related U.S. Application Data
(60) Provisional application No. 62/538,482, filed on Jul. 28, 2017.

(51) Int. Cl. G06F 9/44; G06F 3/0484; G06F 8/38; G06F 8/34; G06F 15/18

(52) U.S. Cl. CPC G06F 9/4443; G06F 3/0484; G06F 15/18; G06F 8/34; G06F 8/38

(57) ABSTRACT

At design-time, a user interface element of a user interface application is defined for use with a Behavior. The Behavior is defined for the defined user interface element. A user interface class is defined for the defined Behavior and registered with the user interface application. A trigger event is defined within the defined user interface class to activate when a particular event is detected by the Behavior.

### RELATED APPLICATIONS

This application claims priority under 35 USC § 120 to U.S. Patent Application Ser. No. 62/538,482, filed on Jul. 28, 2017, the entire contents of which are hereby incorporated by reference.

This application is also related to and filed in conjunction with U.S. Utility patent application Ser. No. ______, filed on ______, entitled “Seamless User-Directed Configuration of Applications During Runtime,” (Attorney Docket No. 22135-1037001/170148US02), which claims priority under 35 USC § 120 with U.S. Provisional Patent Application Ser. No. 62/538,497, filed on Jul. 28, 2017, entitled “Seamless User-Directed Configuration of Applications During Runtime,” (Attorney Docket No. 22135-1037P01/170148US01), the entire contents of each which are hereby incorporated by reference.

### BACKGROUND

The Model-View-Controller (MVC) software architecture has been the predominant approach to building modern desktop and, subsequently, web applications. The MVC approach provides benefits compared to previous software architecture approaches, for example decoupling Model, View, and Controller objects associated with the MVC approach to allow a more flexible and reusable user interface (UI) design, as defined through the View object. However, despite an increase in flexibility and reusability of UI design templates (or, UI patterns, UI elements, and UI controls) as part of the View object, a particular limitation exists between design-time and runtime environments for Applications developed under the MVC approach (“Packaged Applications”). Namely, at runtime, an end user's capability to perform dynamic adaptations of a Packaged Application for specific task needs is limited.

During design-time, the View and Controller objects typically need to be selected and firmly bound to the Model object (that is, an Application object) to define a Packaged Application, including the Packaged Application's presentation, functional scope, and user interaction capabilities. During runtime, in principle, users can perform their tasks only within the scope of the definitional limits of the Packaged Application as specified and implemented at design-time. At runtime under the MVC approach, user options to make modifications to a Packaged Application (for example, to the mentioned presentation, functional scope, and user interaction capabilities) are constrained to exposed configuration options that are bounded by definitional limits preconceived and implemented at design-time.

### SUMMARY

The present disclosure describes building and using behavior-based applications.

In an implementation, at design-time, a user interface element of a user interface application is defined for use with a Behavior. The Behavior is defined for the defined user interface element. A user interface class is defined for the defined Behavior and registered with the user interface application. A trigger event is defined within the defined user interface class to activate when a particular event is detected by the Behavior.

The previously described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, at runtime the described approach does not limit end user modifications of an Application to within the scope of definitional limits of the Application as specified and implemented at design-time as in the Model-View-Controller (MVC) software architecture. Instead, the described approach permits, with respect to both design-time and runtime perspectives, the creation and use of dynamically-configurable Applications, where end users are permitted to make dynamic modifications to presentation, functional scope, and user interaction capabilities of a dynamically-configurable Application. Second, permitting end users to make dynamic modifications to an Application helps to mitigate the need for highly-complex and cost-intensive modifications typically seen with Applications developed under the MVC approach. Third, typically required scheduling/planning for MVC-type Application modifications can be mitigated or eliminated for the end user. Fourth, the need for End User Development (EUD) can also be mitigated or eliminated with the use of dynamically-configurable Applications. Fifth, the described approach uses software entities (“Behaviors”) following a specific programming model that are defined and combined in order to implement a dynamically configurable Application. Sixth, Behaviors are defined as embodiments of user interaction capabilities, which support principles of elasticity (that is, UI or task objects can be manipulated by end users in an adaptive manner which is Context-responsive). In other words, Behaviors embody capabilities for dynamic and Context-responsive user interactions at runtime. From the runtime perspective, end users are permitted to interact with and to manipulate Behaviors in order to dynamically adapt a particular Application to their current task needs. Accordingly, the use of Behaviors allows for a highly-individualized and adaptive user experience. Seventh, the described approach permits better separation of concepts and reusability in comparison to a standard MVC framework. Other advantages will be apparent to those of ordinary skill in the art.

The details of one or more implementations of the subject matter of this specification are set forth in the accompanying drawings and the description. Other features, aspects, and advantages of the subject matter will become apparent from the description, the drawings, and the claims.

### DESCRIPTION OF DRAWINGS

FIG. 1 is a block diagram illustrating a Behavior-based Application Framework (BAF), according to an implementation of the present disclosure.

FIGS. 2A-2C are screenshots of an example software application illustrating an example use of Behaviors in a user interface (UI), according to an implementation of the present disclosure.

FIG. 3 is a block diagram of a Behavior Library class and instantiated Behavior instances, according to an implementation of the present disclosure.

FIG. 4 is a block diagram illustrating movement of Behaviors between applications, according to an implementation of the present disclosure.

FIGS. 5A-5C are screenshots illustrating an example definition of a Behavior in a webpage UI, according to an implementation of the present disclosure.

FIG. 6 is a flowchart of an example method for building and using Behavior-based Applications, according to an implementation of the present disclosure.

FIG. 7 is a block diagram illustrating an example computer system used to provide computational functionalities associated with described algorithms, methods, functions, processes, flows, and procedures as described in the instant disclosure, according to an implementation of the present disclosure.

Like reference numbers and designations in the various drawings indicate like elements.

### DETAILED DESCRIPTION

The following detailed description describes building and using Behavior-based Applications, and is presented to enable any person skilled in the art to make and use the disclosed subject matter in the context of one or more particular implementations. Various modifications, alterations, and permutations of the disclosed implementations can be made and will be readily apparent to those or ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The Model-View-Controller (MVC) software architecture has been the predominant approach to building modern desktop and, subsequently, web applications. The MVC approach provides benefits compared to previous software architecture approaches, for example decoupling Model, View, and Controller objects associated with the MVC approach to allow a more flexible and reusable user interface (UI) design, as defined through the View object. However, despite an increase in flexibility and reusability of UI design templates (or, UI patterns, UI elements, and UI controls) as part of the View object, a particular limitation exists between design-time and runtime environments for Applications developed under the MVC approach (“Packaged Applications”). Namely, at runtime, an end user's capability to perform dynamic adaptations of a Packaged Application for specific task needs is limited.

During design-time, the View and Controller objects typically need to be selected and firmly bound to the Model object (that is, an Application object) to define a Packaged Application, including the Packaged Application's presentation, functional scope, and user interaction capabilities. During runtime, in principle, users can perform their tasks only within the scope of the definitional limits of the Packaged Application as specified and implemented at design-time. At runtime under the MVC approach, user options to make modifications to a Packaged Application (for example, to the mentioned presentation, functional scope, and user interaction capabilities) are constrained to exposed configuration options that are bounded by definitional limits preconceived and implemented at design-time.

For example, even though a UI might permit configuration options for runtime adaptions (such as, UI color, presented UI elements, functionality, and user modes), the configuration options still remain within the constraints of flexibly switching ON or OFF Packaged Application parts, components, or parameters or in flexibly recombining existing Packaged Application parts, components, or parameters. However, each part, component, or parameter remains consistent in presentation, functional scope, and user interaction as defined at design-time.

When end users encounter functional limitations that cannot be overcome by runtime configuration changes, typical practice results in a request made to Packaged Application designers/engineers to modify the Packaged Application with desired changes. As modification of Packaged Applications can be a highly complex and cost-intensive effort, updates to Packaged Applications are normally highly scheduled/planned activities, which can require end users to wait for long periods of time before requested changes to a Packaged Application are available for use. While End User Development (EUD) allows end users to engage in design-time work to make modifications to Packaged Applications outside of typical Packaged Application scheduling/timeframes, EUD is highly dependent upon skill and availability of end users to make requested changes to a Packaged Application. EUD activities can also result in inconsistent or flawed code unless submitted software changes are properly monitored/evaluated before being made available to general end users.

Described is a software architecture that removes the previously-described particular limitation of Packaged Applications and provides a concept of Application “elasticity.” The described software architecture permits, with respect to both design-time and runtime perspectives, the creation and use of dynamically-configurable Applications (“Elastic Applications”) in presentation, functional scope, and user interaction capabilities. While this disclosure focuses generally on web-type applications for examples, as will be apparent to those of ordinary skill in the art, the described concepts can be applied to other Application types. Accordingly, other Application types consistent with the concepts presented in this disclosure are considered to be within the scope of this disclosure.

Software entities (“Behaviors”) following a specific programming model are at the heart of the described software architecture. Behaviors are associated with each element of a UI where elastic behavior is desired. For example, “class Behavior extends HTMLElement.” In this way, each UI element of type HTMLElement includes associated Behavior functionality for use.

From a design-time perspective, Behaviors can be defined and combined in order to implement an Elastic Application (that is, a Behavior-based Application), at least in terms of an Elastic Application default value, which can be dynamically modified by end users at runtime. From a runtime perspective, end users are permitted to interact with and to manipulate Behaviors in order to dynamically adapt a particular Elastic Application to their current task needs. The use of Behaviors allows for a highly-individualized and adaptive user experience.

Behaviors are defined as embodiments of user interaction capabilities, which support principles of elasticity (that is, UI or task objects can be manipulated by end users in an adaptive manner which is context-responsive). In other words, Behaviors embody capabilities for dynamic and context-responsive user interactions at runtime.

At a high-level, to implement Behaviors which are effective at runtime, functions need to be applied to data in a contextually-adaptive, dynamic manner. Specifically, end users should have options to dynamically attach or to detach particular Behaviors during use with respect to a particular Context (for example, an Application). Consequently, functions which are entailed with a particular Behavior are activated or deactivated, respectively. Defining Behaviors in terms of elements fulfills an elasticity requirement during runtime, resulting in Elastic Applications.

In some implementations, JAVASCRIPT technologies are used through a web browser to operate on Document Object Models (DOM) commonly available for webpages. While this disclosure focuses generally on JAVASCRIPT technologies (for example, using the standardized ECMAScript language under ECMA-262 and ISO/IEC 16262), as will be apparent to those of ordinary skill in the art, the described concepts can be realized using different language or other technologies. Accordingly, other technology types consistent with the concepts presented in this disclosure are considered to be within the scope of this disclosure.

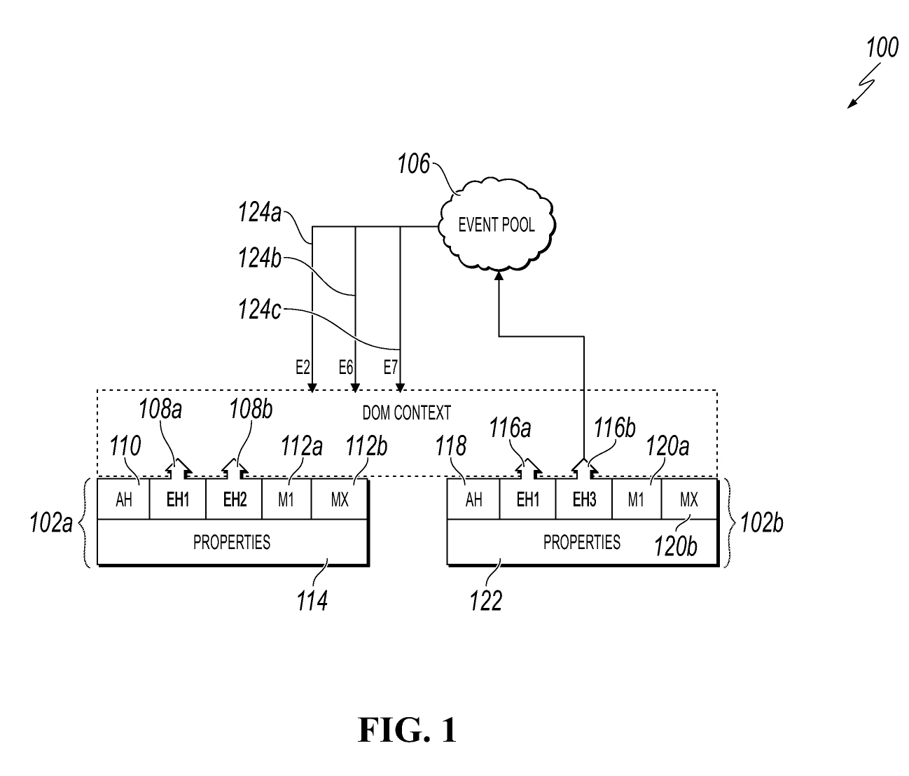

FIG. 1 is a block diagram illustrating an example Behavior-based Application Framework (BAF) 100, according to an implementation of the present disclosure. For the purposes of this disclosure, and in some implementations:
Event (E): Includes a name, a Context trigger, and optionally some data.

For an Event associated with a website, an Event could be in the form of a tuple (for example, “{‘click’, button}”). Here, the Event name is ‘click’ and the Context is some button that an end user clicked on. In other implementations, Events can be structured in any way consistent with this disclosure,
Event Pool: An abstract collection of all Events generated either by an end user or Behaviors,
DOM Context: A specific implementation of the described BAF 100 utilizes a DOM, where all of the interface resides in memory (for example, as a tree of hash maps). In this example, when an Event is triggered on a particular Context, the Event migrates up the tree of hash maps to the root element of the tree, and
Behaviors (or, interchangeably, “Behaviour”): A Behavior is a collection of:
   Event Handler(s) (EH): Functions that react to specific events on an Event Context basis and fire new Events. This means that after reacting to a Context, an EH can optionally fire new events. For instance, a Behavior can have an Event Handler that listens for an end user click action on a particular button (the Event Context) associated with a webpage. Once the ‘click’ on the particular button is detected, the Event Handler can then trigger a new ‘page-blink’ event associated with the webpage. As an example at a lower level, a database connection behaviour can wait for a user to input a query into a search field (the typing will trigger a native ‘input’ event that can be monitored). The database connection behaviour will then search for records in the database. Once a match is found for the native input event, the database connection behaviour can trigger a ‘records-found’ event in the Context the Behavior is in,
   Attached Handler (AH): A special Event Handler called a “connected” or “attached” Handler, which is called whenever a Behavior is attached to a specific Context. In contrast, and with respect to the previous example, an EH is a function that searches in a database and ‘handles’ a particular event (for example, the event of the user typing text into a search field). EH's listen within a Context, meaning that the function that searches the database only listens for input events in the Context it is placed in (for example, the same application) and not to other events (for example, when the user types in something in other irrelevant search fields).
   Method(s) (M): Methods, unlike event handlers, do not listen for Events, but are called explicitly by Event Handlers, and
   Properties: Describe a state of a Behavior. The state can change in-between invocations of an EH. The Properties are parameters of EHs and AHs. For example, a “database search” Behavior could have the database URL as a parameter.

As illustrated, the example BAF 100 includes Behaviors 102a and 102b, a DOM Context (Context) 104, and an Event Pool 106. Consistent with the description above, Behavior 102a includes EH1 108a/EH2 108b, AH 110, M1 112a/MX 112b, and Properties 114. Behavior 102b includes EH1 116a/EH3 116b, AH 118, M1 120a/MX 120b, and Properties 122. Events 124a/124b/124c are also illustrated.

In FIG. 1, EH1 108a (associated with Behavior 102a) and EH1 116a/EH3 116b (associated with Behavior 102b) are in a “listening” state. Conversely, EH2 108b (Behavior 102a) is not in a “listening” state because an associated Event (E2 124a) triggered EH2 108b on a Context 104 and EH2 108b is considered to be instead currently “handling” Event 124a. Note that in some implementations, multi-threaded EHs are capable of handling multiple Events in parallel so that a particular EH is not locked while handling an Event. In typical implementations, the described framework depends upon functionality provided by modern JAVASCRIPT engines and a native event Application Programming Interface (API) implementation (on top of a particular DOM). Note that Events E6 124b and E7 124c may have occurred, but neither of the illustrated AHs or EHs in Behaviors 102a and 102b are listening for these specific Events.

In a particular implementation, a Behavior could be defined similar to:

| | |
|---|---|
| 1 | /** |
| 2 | * A basic Behavior framework |
| 3 | **/ |
| 4 | class Behavior extends HTMLElement |
| 5 | { |
| 6 | /** |
| 7 | * Interactions are eventName: handlerfunction array. |
| 8 | * When the Behavior is attached / detached or when an |
| 9 | * attribute of the Behavior is changed, interactions |
| 10 | * are reset automatically |
| 11 | **/ |
| 12 | get interactions( ){ return [ ]} |
| 13 | /** |
| 14 | * A list of parameters together with default values passed through |

attribute value pairs

| | |
|---|---|
| 15 | **/ |
| 16 | get parameters( ){ return { }} |
| 17 | /** |
| 18 | * A storage of the bound event listeners (interactions) |
| 19 | **/ |
| 20 | get boundEventListeners( ) |
| 21 | { |
| 22 | if (this._boundEventListeners === undefined) |
| 23 | this._boundEventListeners = new Array( ) |
| 24 | return this._boundEventListeners |
| 25 | } |
| 26 | set boundEventListeners(arr){ this._boundEventListeners = arr} |
| 27 | /** |
| 28 | * Get all of the parameters |
| 29 | **/ |
| 30 | constructor(params) |
| 31 | { |
| 32 | super( ) |
| 33 | // Set the visuals |
| 34 | this.classList.add(‘behaviour’) |
| 35 | this.innerHTML = this.constructor.name |
| 36 | // create the parameters |
| 37 | Object.keys(this.parameters).forEach(p => |
| 38 | { |
| 39 | Object.defineProperty(this, p, |
| 40 | { |
| 41 | set: v => this.setAttribute(p, v), |
| 42 | get: n => this.getAttribute(p) |
| 43 | }) |
| 44 | // Set the default value |
| 45 | this[p] = this[p] \|\| (params && params[p]) \|\| this.parameters[p] |
| 46 | }) |
| 47 | } |
| 48 | /** |
| 49 | * Bind all event listeners in the interactions |
| 50 | **/ |
| 51 | connectedCallback( ) |
| 52 | { |
| 53 | // Save the contect |
| 54 | this.$context = this.parentNode |
| 55 | // Go through the interactions and bind them |
| 56 | this.interactions.forEach(i => |
| 57 | { |
| 58 | let trigger = i[0] |
| 59 | let events = i[1] |
| 60 | let handler = i[2].bind(this) |
| 61 | // Type checking |
| 62 | { |
| 63 | this.typeCheck(trigger, HTMLElement) |
| 64 | this.typeCheck(events, Array) |
| 65 | this.typeCheck(handler, Function) |
| 66 | } |
| 67 | // Bind the events and save them |
| 68 | { |
| 69 | events.forEach(e => trigger.addEventListener(e, handler)) |
| 70 | events.forEach(e => this.boundEventListeners.push({trigger, |

events, handler}))

| | |
|---|---|
| 71 | } |
| 72 | }) |
| 73 | this.dispatchEvent(new Event(‘connected’)) |
| 74 | } |
| 75 | /** |
| 76 | * Remove all of the bindings |
| 77 | **/ |
| 78 | disconnectedCallback( ) |
| 79 | { |
| 80 | this.dispatchEvent(new Event(‘disconnected’)) |
| 81 | this.boundEventListeners.forEach( |
| 82 | triplet => triplet.events.forEach(e => |
| 83 | triplet.trigger.removeEventListener(e, triplet, handler))) |
| 84 | this.boundEventListeners = new Array( ) |
| 85 | } |
| 86 | typeCheck(element, type) |
| 87 | { |
| 88 | if (!(element instanceof type)) |
| 89 | throw ‘Error in trying to bind interaction. ${element} is not |

of type ${type}’

| | |
|---|---|
| 90 | } |
| 91 | }. |

As will be appreciated by those of ordinary skill in the art, there are a multitude of possible ways to define a Behavior consistent with this disclosure in software. The presented example is not meant for understanding and not to limit the disclosure in any way. Other implementations of Behaviors consistent with this disclosure are also considered to be within the scope of this disclosure.

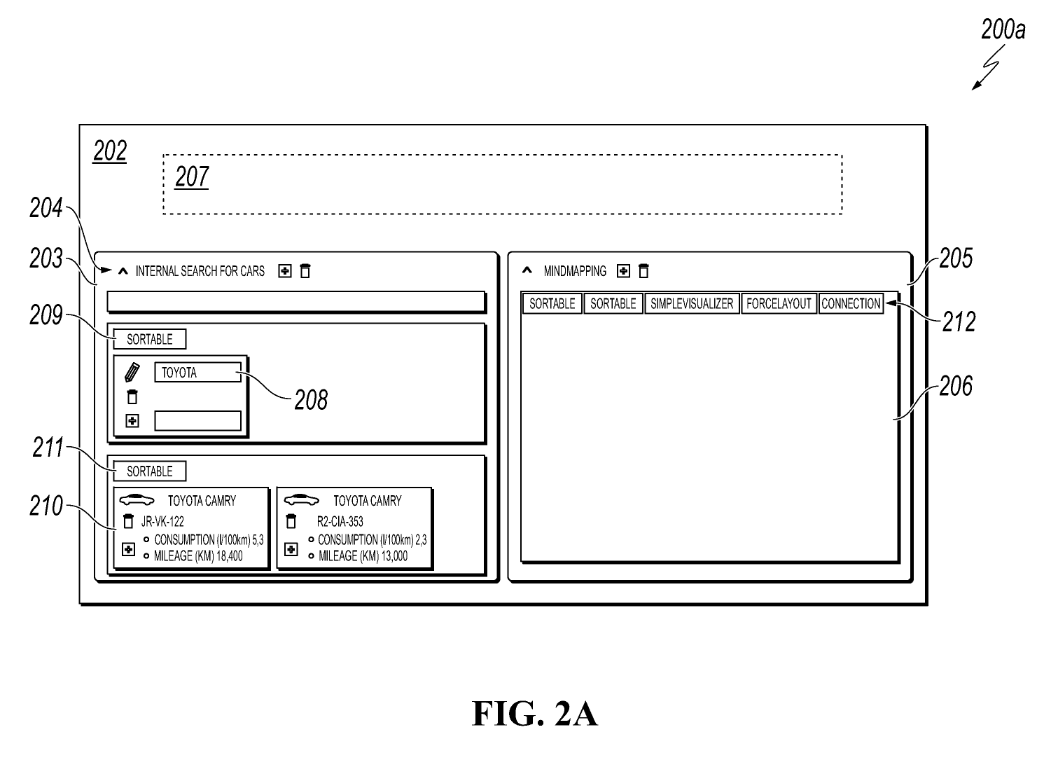

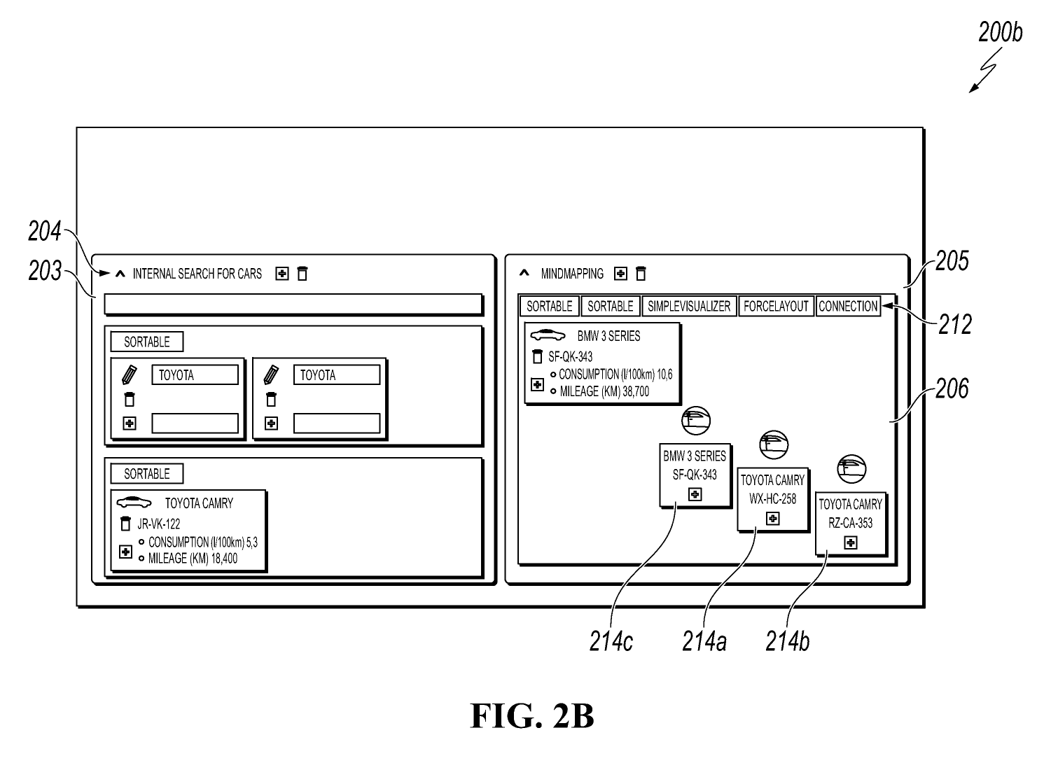

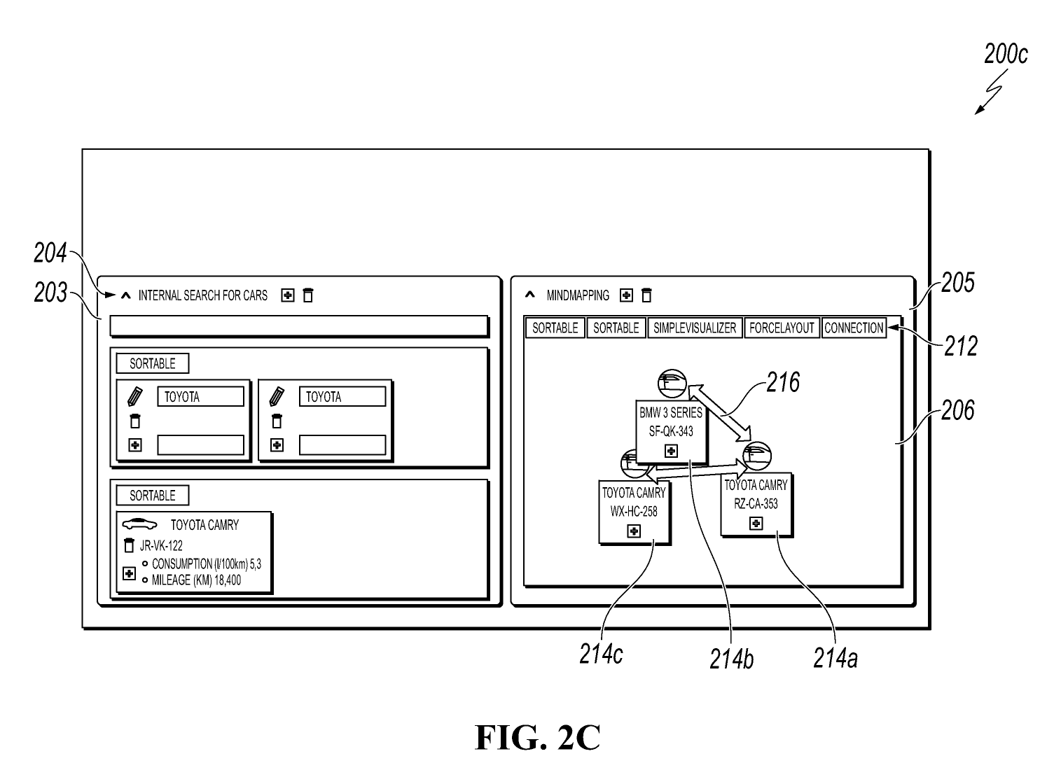

With respect to FIGS. 2A-2C, 3-4, and 5A-5C, and as will be understood by those of ordinary skill in the art, there are multiple possible implementations of any aspect (whether illustrated or not) of the figures (for example, applications, visualizations, data values, graphical layouts, functionality, and design choices). These figures are provided to demonstrate one or more aspects of and to assist with understanding of the described subject matter. No representation is made that any of the descriptions are complete, nor are the figures and descriptions meant to be limiting to the disclosed subject matter in any way. Other implementations of the described subject matter, consistent with this disclosure, are also considered to be within the scope of this disclosure.

FIGS. 2A-2C are screenshots 200a-200c, respectively, of an example software application illustrating an example use of Behaviors in a UI, according to an implementation of the present disclosure.

Turning to FIG. 2A, FIG. 2A illustrates a dashboard UI 202 executed in a web browser or other application. The dashboard UI 202 is dual-paned, with each pane representing a different application and with a Behavior holding area 207. The left pane 203 contains a database search application 204 (“Internal Search for Cars”) that can use UI search interface 208 for data entry. For example, searching for an automotive make “Toyota” with UI search interface 208 returns results 210. Note that the UI search interface 208 is illustrated within a portion of left pane 203 associated with a Behavior 209 (here, “Sortable”), that sorts the items within this region by some value (for example, name).

As illustrated, the results 210 (if applicable) are represented in application 204 within a graphical item displaying a name, item number, fuel consumption, and mileage value. Note that the results 210 are associated with a Behavior 211 (here, “Sortable”), that sorts the results by some value (for example, name, item number, fuel consumption, or mileage value).

The right pane 205 contains a graph building application 206 (“Mindmapping”). At the top of right pane 206 are graphical representations of example Behaviors 212 as previously described. For example, Behaviors 212 include “Sortable,” “Simple Visualizer,” “Force Layout,” and “Connection.”

Turning to FIG. 2B, if UI result elements (210) from application 204 are dragged into application 206, the display characteristics of each UI result element 210 change to incorporate the defined Behaviors 212 associated with application 206. For example, as illustrated, each result 210 is visually transformed and displayed as a circular type icon (here, icons 214a, 214b, and 214c) with just a name and item number. The illustrated name and item number reflects the defined behaviors 212 (for example, for at least the “Simple Visualizer” Behavior). Additionally, application 206 separates visualized results such as 214 so that two results can be visually connected (for example, using a UI select-and-drag-type action) according to the “Connection” Behavior in a graph like format with a connection (for example, connection 216) as illustrated in FIG. 2C.

Turning back to FIG. 2A, note that if an example Behavior 212 is dragged out of application 206 into the Behavior holding area 207 (for example, “Simple Visualizer”), that particular Behavior 212 is no longer applicable to application 206. In this case, the Behavior holding area 207 would display the Behavior 212 and permit the Behavior 212 to be dragged back into application 206 or other portion of the dashboard UI 202. For this example, the simple UI visualizations in FIG. 2C would revert to boxes (as illustrated by result 210) unless a different Behavior 212 affected the look of the UI element. Adding the Behavior 212 back into the application would then reapply the Behavior 212 to the UI elements affected by the Behavior 212.

Similarly, dragging a Behavior 212 from the application 206 to the application 204 would apply the Behavior 212 appropriately to application 204. For example, if the “Simple Visualizer” Behavior 212 was dragged to the results area (holding results 210), results 20 would change in appearance to simple visualizations as illustrated in FIGS. 2B & 2C (icons 214a, 214b, and 214c).

Note also that if Behaviors associated with application 204 (for example, Behavior “sortable” 209 and 211) are removed (for example, deleted, dragged to another region of application 204, dragged to application 206, or dragged to the Behavior holding area 207), the applicable region of application 204 would no longer be subject to the “sortable” Behavior. As can be seen, Behaviors are movable from one application to another to affect UI elements configured to be subject to particular Behaviors. Behaviors can also be configured to be, for example, cloneable, deletable, read-only, or according to some other attribute consistent with this disclosure.

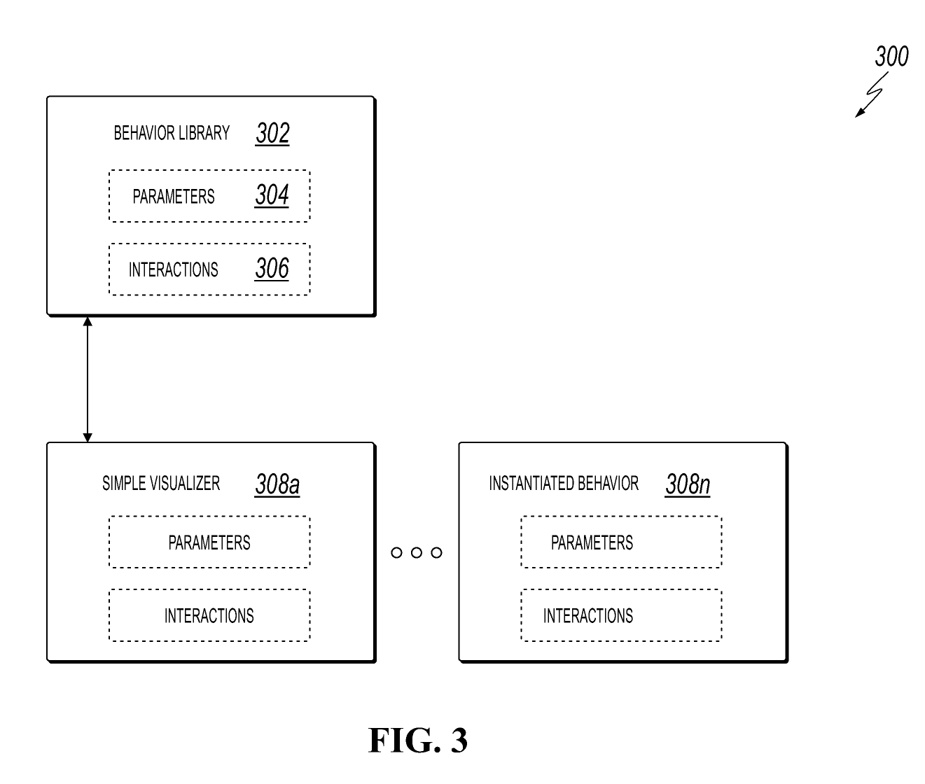

FIG. 3 is a block diagram 300 of a Behavior Library class and instantiated Behavior instances, according to an implementation of the present disclosure. As illustrated, Behavior Library 302 (for example, Behaviors.js) is a class of the described framework representing a single Behavior. Multiple Behavior Libraries 302 can be configured to work together as an application (that is, an application is made up of one or more Behaviors—similar to application 206 in FIG. 2A with multiple Behaviors 212). Parameters 304 and Interactions 306 represent functions (analogous to an API) for interacting with a particular Behavior. Other functions, although not illustrated, are possible. For example, a “Constructor” function used to instantiate a particular Behavior and for “ConnectedCallback”, “DisconnectedCallback”, and any other function consistent with this disclosure.

Additionally, for each specific type of Behavior, the Parameters 304 and Interactions 306 can vary to support different Behavior functionality. As specific examples, a “Connection” Behavior can have a “Strength” Parameter 304 and “connected”, “dragend”, and “physics changed” Interactions 306. A “Sortable” Behavior can have “pull”, “put”, and “group” Parameters 304 and a “connected” Interaction 306. A “Simple Visualizer” Behavior can have a “constructor function” Parameter 304 and “disconnected”, “connected”, and “dragend” Interactions 306. Finally, a “Force Layout” Behavior can have a “strength” Parameter 304 and “disconnected”, “connected”, and “dragend” Interactions 306.

An instantiated Behavior, for example, Behavior 308a (Simple Visualizer) is an instance of the Behavior Library 302 and represents the specified Behavior. As illustrated, one or more instances of the same Behavior or other Behaviors (for example, Instantiated Behavior 308n) can be instantiated from the illustrated Behavior Library 302. Elements of the framework (for example, Behaviors) interact with other instances of the framework through Events, as previously described.

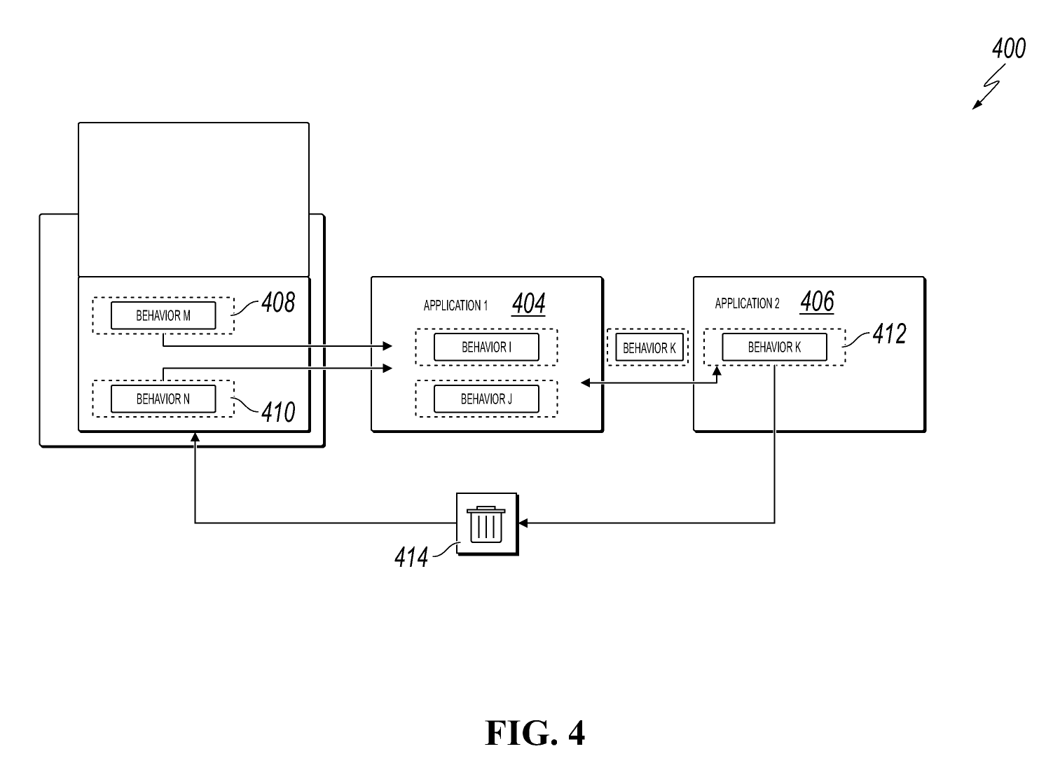

FIG. 4 is a block diagram 400 illustrating movement of Behaviors between applications, according to an implementation of the present disclosure. For example, FIG. 4 provides an additional view and Context for the description of applications and Behaviors associated with FIGS. 2A-2C. FIG. 4 also illustrates that Behaviors are not static in nature. Behaviors can be associated with applications and added and deleted at runtime. For example, if a Behavior provides connection to a database for an application and the Behavior is deleted, connection to the database is no longer possible. If connection to the database is desired at a later point, an appropriate Behavior can be added to the application to restore the functionality (or a different, more appropriate Behavior with slightly different functionality).

As illustrated, a Search Application 402 (for example, similar to application 204 in FIG. 2A), Application 1 404, and Application 2 406 each contain Behaviors. As an example, Behavior m 408 and Behavior n 410 can be dragged and dropped from Search Application 402 and into Application 1 404. Similarly, Behavior k 412 in Application 2 406 can be dragged between Application 2 406 and Application 1 404. FIG. 4 also illustrates that Behavior k 412 can be deleted (for example, stored in a holding area or clipboard 414) and added to Search Application 402. It should be noted that not all possible drag-and-drop functionality is illustrated with respect to FIG. 4. For example, the illustrated drag-and-drop actions between Search Application 402 and Application 1 404 are shown to be unidirectional. In other implementations, the drag-and-drop functionality can be bidirectional as illustrated between Application 1 404 and Application 2 406. Likewise, in some implementations, the illustrated delete/add functionality with respect to 414 can be bi-directional.

In some implementations, Behaviors can be used to permit an entire source application and associated Behaviors to be incorporated into a target application. In this case, the target application would incorporate the source application and associated Behaviors.

In some implementations, principles of machine learning technologies (for example, machine learning algorithms, artificial intelligence engines, or pattern matching algorithms) can be used to predict which elements of a webpage are useful objects (for example, business objects) that contribute knowledge with respect to the webpage and to modify Behaviors appropriately. For example, on an airline reservation webpage, a menu is not a business object because outside of the webpage, a menu does not generally contribute useful knowledge with respect to an airline reservation webpage, but lists of airline flights, flight times, and the like are very useful with respect to the airline reservation webpage. With respect to Behaviors, the knowledge gathered by the machine learning algorithm can be used with respect to business objects that can be affected by one or more Behaviors (for example, Sortable or Simple Visualizer). With the gathered knowledge, one or more Behaviors can be parameterized for enhanced functionality. As an example, a particular Behavior can be parameterized to receive the size of a list of airline data and to adjust the size of a UI widget appropriately or to display particular information deemed most important within the widget.

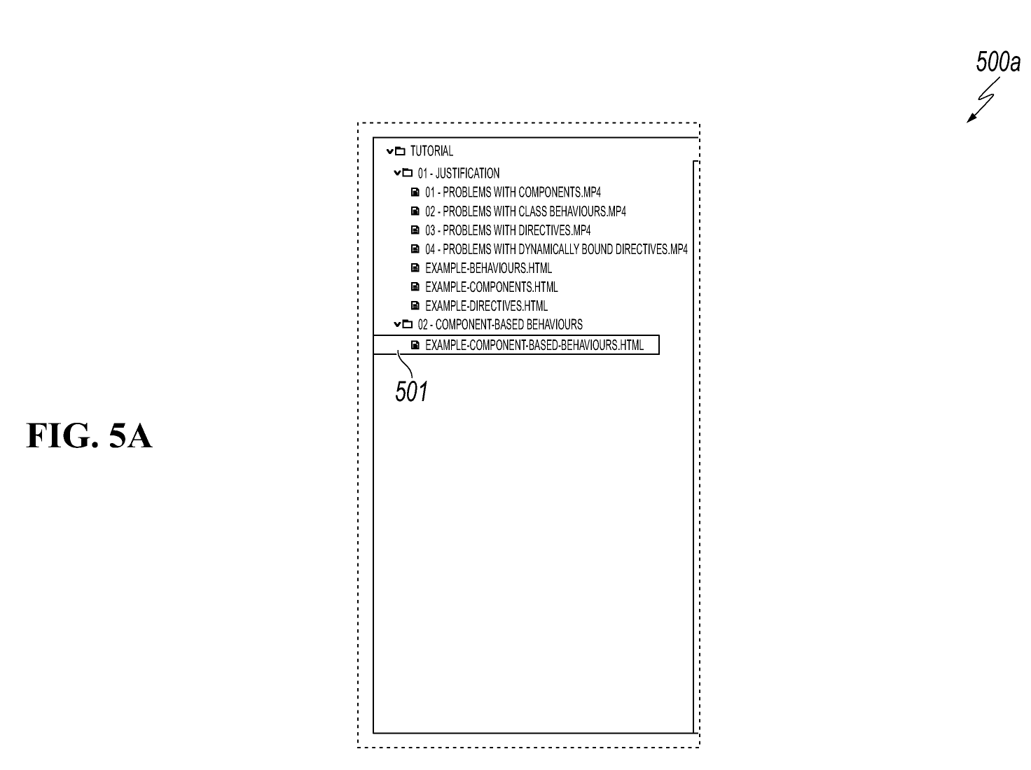

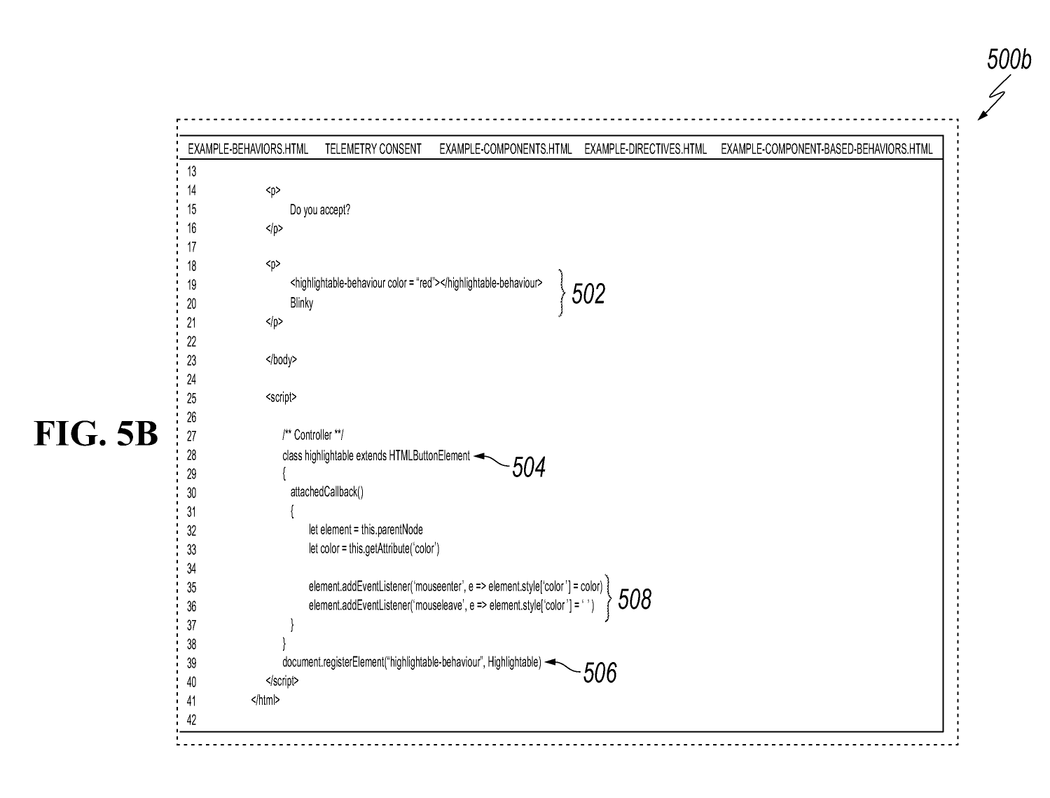

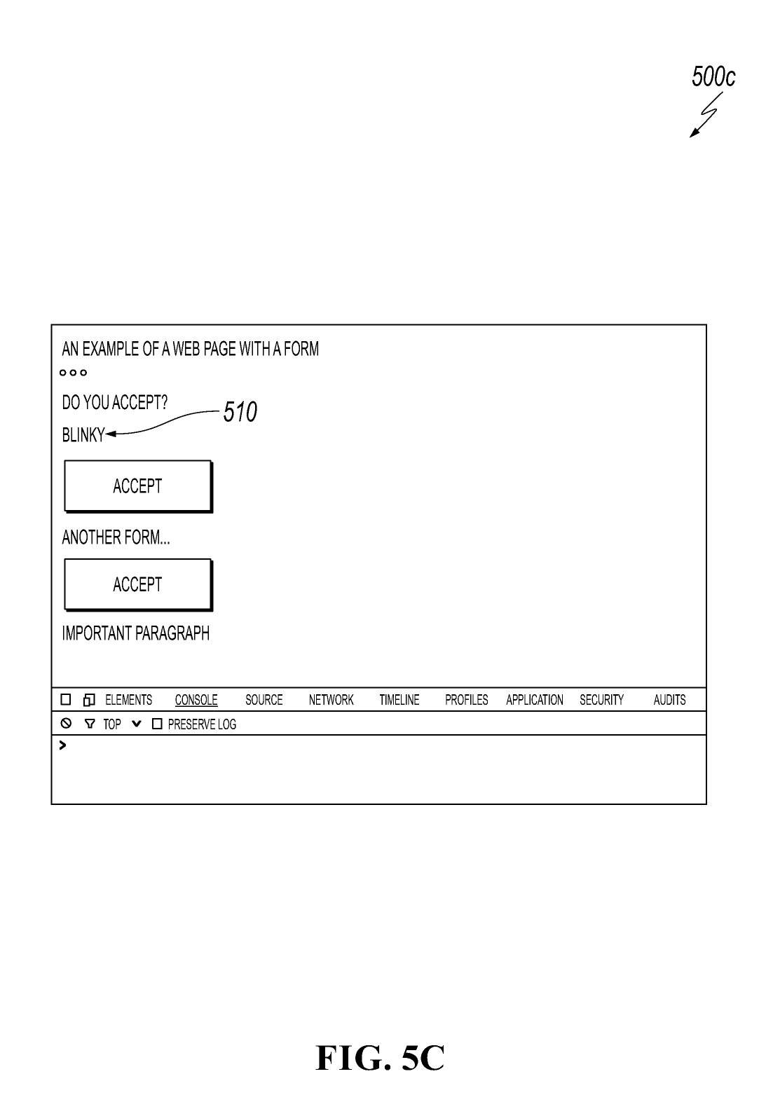

FIGS. 5A-5C are screenshots 500a-500c, respectively, illustrating an example definition of a Behavior in a webpage UI, according to an implementation of the present disclosure.

Turning to FIG. 5A, FIG. 5A illustrates a code selection graphical user interface (GUI) 500a with selected sample code 501 (here, “Example-Component-Based-Behaviours.HTML”) used to define a Behavior as described in this disclosure. For example, turning to FIG. 5B, FIG. 5B is a sample code listing 500b of an example component-based behavior corresponding to selected sample code 501 in FIG. 5A. In FIG. 5B, a UI element is defined (here a paragraph with the text “Blinky” at 502). Behavior is then defined for the element (here, the paragraph with “Blinky” text has a “highlightable-behaviour” defined at 502). A class is then defined for the Behavior (here, “highlightable extends HTMLButtonElement” at 504). The Behavior is then registered by passing the defined class to a register function (for example, at 506). Trigger Events are then defined in the class to bind/activate when particular Events associated with the element are detected (for example, addEventListener at 508 for particular events “mouseenter”, “mouseleave”, etc.). The defined Behavior is then tested.

Turning to FIG. 5C, FIG. 5C illustrates a webpage UI 500c with the defined element and Behavior of FIGS. 5A & 5B, according to an implementation of the present disclosure. Element 510 (paragraph with “Blinky” text) is listening for mouseenter and mouseleave events with respect to the paragraph. Upon mousenter, the text color will be changed to red (as defined in the “highlightable-behavior” Behavior definition at 502 in FIG. 5B). In FIG. 5C, a mouseenter event has not been detected so the “Blinky” text is black in color (that is, a default color). Once the mouse pointer generates a mouseenter event with respect to the paragraph (for example, moving the mouse pointer over the “Blinky” text), “Blinky” will turn red as defined (not illustrated). Moving the mouse pointer away from the paragraph and generating a mouseleave event, the text will turn back to black.

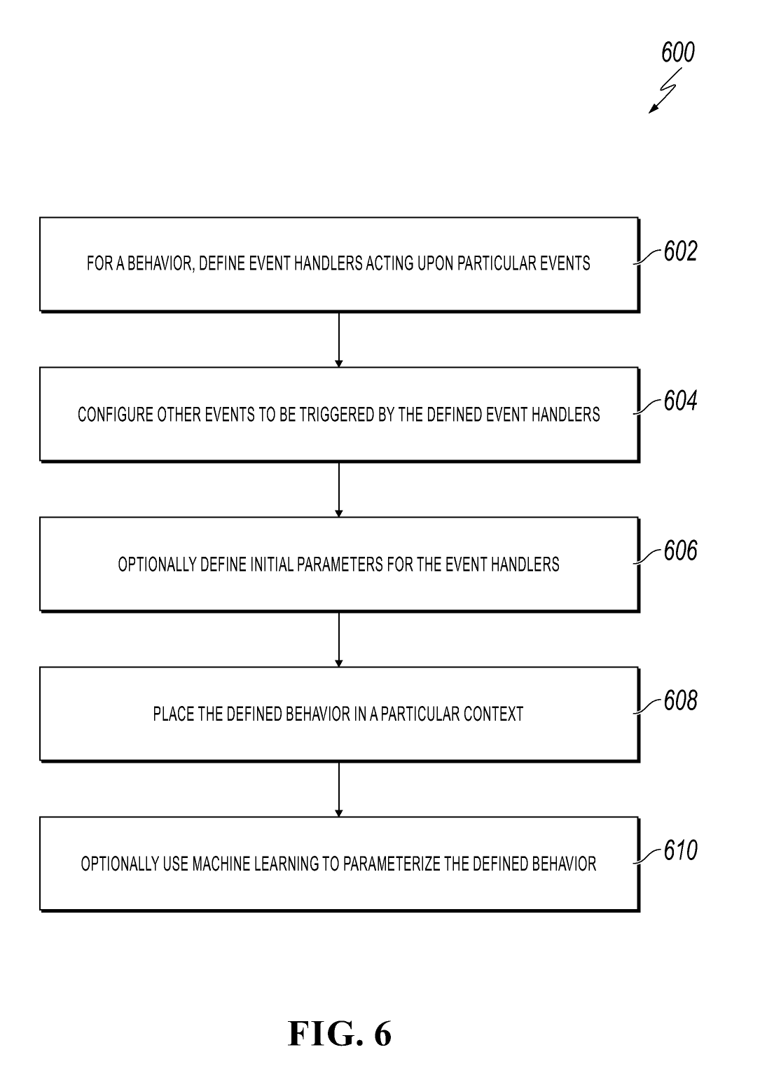

FIG. 6 is a flowchart of an example method 600 for using Behavior-based Applications, according to an implementation of the present disclosure. For clarity of presentation, the description that follows generally describes method 600 in the context of the other figures in this description (and, particularly, the description with respect to FIGS. 5A & 5B). However, it will be understood that method 600 may be performed, for example, by any suitable system, environment, software, and hardware, or a combination of systems, environments, software, and hardware, as appropriate. In some implementations, various steps of method 600 can be run in parallel, in combination, in loops, or in any order.

At design time, for a Behavior:

At 602, define one or more event handlers (functions) for a Behavior that act upon a particular event, given a Context the particular event will be bound to at runtime. For example, refer to the description with respect to FIGS. 5A & 5B. From 602, method 600 proceeds to 604.

At 604, the defined event handlers are configured to trigger one or more other events upon detection of the particular event. From 604, method 600 proceeds to 606.

At 606, optionally, initial parameters can be provided for the event handlers. From 606, method 600 proceeds to 608.

At run time, for the defined Behavior:

At 608, place the defined Behavior in a particular Context (application). From 608, method 600 proceeds to 610.

At 610, optionally use machine learning technologies to further parameterize the Behavior based on the usage. After 610, method 600 stops.

As a particular example, a “Draw Arrows” Behavior is defined (for example, in FIGS. 2A-2C, the “Mindmapping” application 206) to permit the addition of arrow (for example, connection 216 in FIG. 2C). An event handler can be provided for a “left-mouse-press-down” and “left-mouse-release” events. Here, define that when a user presses down on a left mouse button (“left-mouse-press-down” event), a detection is performed if the left press was on an object (a node) in a graph. If YES, start drawing an arrow from the node by following the mouse pointer. Define that when the user releases the left mouse button (“left-mouse-release” event), a determination is made as to whether the left release was over a different node in the graph. If YES, draw the arrow and trigger a “two-nodes-connected” event in the same Context. If NO, no arrow is drawn between the nodes (but some other action could be performed). The defined event handler could be optionally configured to provide parameters (for example, width, color, and pattern of the drawn arrows). The defined Behavior is then placed into a graph application (for example, application 206 in FIGS. 2A-2C). Optionally, machine learning technologies can be used to learn the ideal width, color, or pattern of the arrows based on the distance between the nodes, the amount of display real estate available for display, and the like.

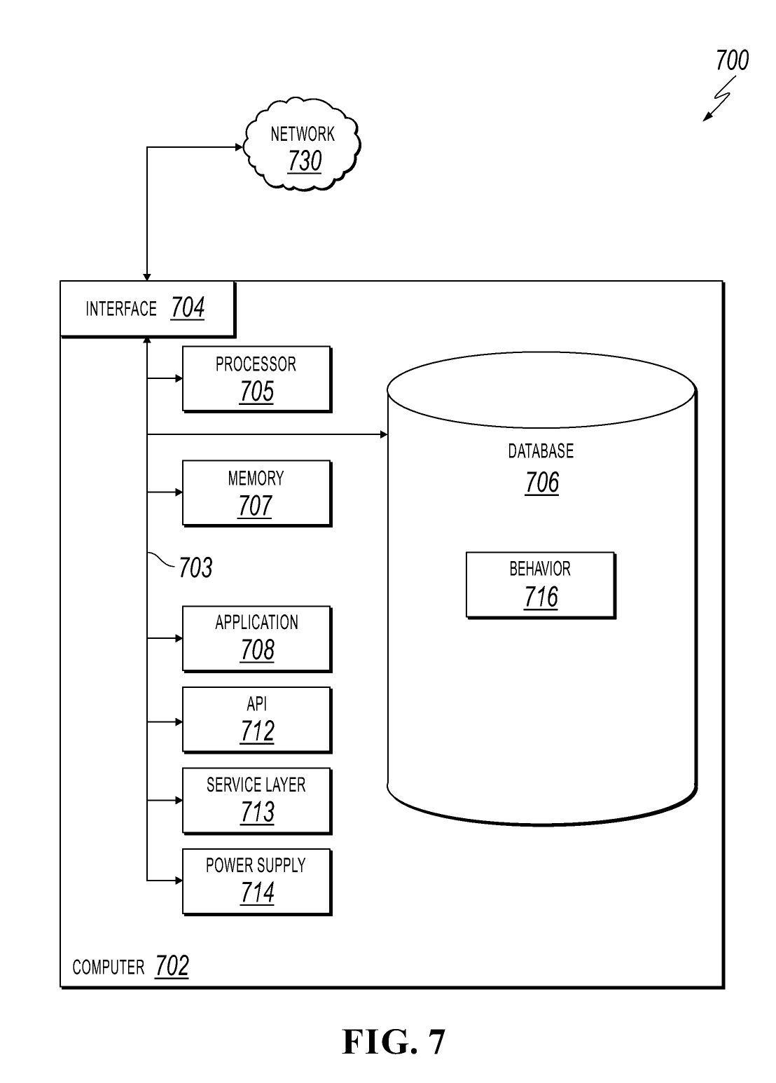

FIG. 7 is a block diagram of an example computer system 700 used to provide computational functionalities associated with described algorithms, methods, functions, processes, flows, and procedures, as described in the instant disclosure, according to an implementation of the present disclosure. The illustrated computer 702 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 702 may comprise a computer that includes an input device, such as a keypad, keyboard, touch screen, or other device that can accept user information, and an output device that conveys information associated with the operation of the computer 702, including digital data, visual, or audio information (or a combination of information), or a graphical-type user interface (UI) (or GUI).

The computer 702 can serve in a role as a client, network component, a server, a database or other persistency, or any other component (or a combination of roles) of a computer system for performing the subject matter described in the instant disclosure. The illustrated computer 702 is communicably coupled with a network 730. In some implementations, one or more components of the computer 702 may be configured to operate within environments, including cloud-computing-based, local, global, or other environment (or a combination of environments).

At a high level, the computer 702 is an electronic computing device operable to receive, transmit, process, store, or manage data and information associated with the described subject matter. According to some implementations, the computer 702 may also include or be communicably coupled with an application server, e-mail server, web server, caching server, streaming data server, or other server (or a combination of servers).

The computer 702 can receive requests over network 730 from a client application (for example, executing on another computer 702) and respond to the received requests by processing the received requests using an appropriate software application(s). In addition, requests may also be sent to the computer 702 from internal users (for example, from a command console or by other appropriate access method), external or third-parties, other automated applications, as well as any other appropriate entities, individuals, systems, or computers.

Each of the components of the computer 702 can communicate using a system bus 703. In some implementations, any or all of the components of the computer 702, hardware or software (or a combination of both hardware and software), may interface with each other or the interface 704 (or a combination of both), over the system bus 703 using an application programming interface (API) 712 or a service layer 713 (or a combination of the API 712 and service layer 713). The API 712 may include specifications for routines, data structures, and object classes. The API 712 may be either computer-language independent or dependent and refer to a complete interface, a single function, or even a set of APIs. The service layer 713 provides software services to the computer 702 or other components (whether or not illustrated) that are communicably coupled to the computer 702. The functionality of the computer 702 may be accessible for all service consumers using this service layer. Software services, such as those provided by the service layer 713, provide reusable, defined functionalities through a defined interface. For example, the interface may be software written in JAVA, C++, or other suitable language providing data in extensible markup language (XML) format or other suitable format. While illustrated as an integrated component of the computer 702, alternative implementations may illustrate the API 712 or the service layer 713 as stand-alone components in relation to other components of the computer 702 or other components (whether or not illustrated) that are communicably coupled to the computer 702. Moreover, any or all parts of the API 712 or the service layer 713 may be implemented as child or sub-modules of another software module, enterprise application, or hardware module without departing from the scope of this disclosure.

The computer 702 includes an interface 704. Although illustrated as a single interface 704 in FIG. 7, two or more interfaces 704 may be used according to particular needs, desires, or particular implementations of the computer 702. The interface 704 is used by the computer 702 for communicating with other systems that are connected to the network 730 (whether illustrated or not) in a distributed environment. Generally, the interface 704 comprises logic encoded in software or hardware (or a combination of software and hardware) and is operable to communicate with the network 730. More specifically, the interface 704 may comprise software supporting one or more communication protocols associated with communications such that the network 730 or interface's hardware is operable to communicate physical signals within and outside of the illustrated computer 702.

The computer 702 includes a processor 705. Although illustrated as a single processor 705 in FIG. 7, two or more processors may be used according to particular needs, desires, or particular implementations of the computer 702. Generally, the processor 705 executes instructions and manipulates data to perform the operations of the computer 702 and any algorithms, methods, functions, processes, flows, and procedures as described in the instant disclosure.

The computer 702 also includes a database 706 that can hold data for the computer 702 or other components (or a combination of both) that can be connected to the network 730 (whether illustrated or not). For example, database 706 can be an in-memory, conventional, or other type of database storing data consistent with this disclosure. In some implementations, database 706 can be a combination of two or more different database types (for example, a hybrid in-memory and conventional database) according to particular needs, desires, or particular implementations of the computer 702 and the described functionality. Although illustrated as a single database 706 in FIG. 7, two or more databases (of the same or combination of types) can be used according to particular needs, desires, or particular implementations of the computer 702 and the described functionality. While database 706 is illustrated as an integral component of the computer 702, in alternative implementations, database 706 can be external to the computer 702. As illustrated, the database 706 holds a Behavior 716, as previously described.

The computer 702 also includes a memory 707 that can hold data for the computer 702 or other components (or a combination of both) that can be connected to the network 730 (whether illustrated or not). Memory 707 can store any data consistent with this disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same or combination of types) can be used according to particular needs, desires, or particular implementations of the computer 702 and the described functionality. While memory 707 is illustrated as an integral component of the computer 702, in alternative implementations, memory 707 can be external to the computer 702.

The application 708 is an algorithmic software engine providing functionality according to particular needs, desires, or particular implementations of the computer 702, particularly with respect to functionality described in this disclosure. For example, application 708 can serve as one or more components, modules, or applications. Further, although illustrated as a single application 708, the application 708 may be implemented as multiple applications 708 on the computer 702. In addition, although illustrated as integral to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion or management circuits (including recharging, standby, or other power management functionality). In some implementations, the power-supply 714 can include a power plug to allow the computer 702 to be plugged into a wall socket or other power source to, for example, power the computer 702 or recharge a rechargeable battery.

There may be any number of computers 702 associated with, or external to, a computer system containing computer 702, each computer 702 communicating over network 730. Further, the term “client,” “user,” and other appropriate terminology may be used interchangeably, as appropriate, without departing from the scope of this disclosure. Moreover, this disclosure contemplates that many users may use one computer 702, or that one user may use multiple computers 702.

Described implementations of the subject matter can include one or more features, alone or in combination.

For example, in a first implementation, a computer-implemented method, comprising: at design-time, by operation of a computer: defining a user interface element of a user interface application for use with a Behavior; defining the Behavior for the defined user interface element; defining a user interface class for the defined Behavior; registering the defined Behavior with the user interface application; and defining a trigger event within the defined user interface class to activate when a particular event is detected by the Behavior.

The foregoing and other described implementations can each, optionally, include one or more of the following features:

A first feature, combinable with any of the following features, wherein the defined UI class includes an event handler for detecting the particular event.

A second feature, combinable with any of the previous or following features, further comprising triggering the trigger event upon detection of the particular event.

A third feature, combinable with any of the previous or following features, wherein the event handler is defined for the defined user interface class based upon a particular Context that the particular event will be bound to at runtime.

A fourth feature, combinable with any of the previous or following features, further comprising, at runtime, placing the defined Behavior within a particular Context.

A fifth feature, combinable with any of the previous or following features, wherein registering the Behavior with the user interface application further comprises passing the defined user interface class to a register function.

A sixth feature, combinable with any of the previous or following features, further comprising, at runtime, testing the Behavior in the user interface application.

In a second implementation, a non-transitory, computer-readable medium storing one or more instructions executable by a computer system to perform operations comprising: at design-time: defining a user interface element of a user interface application for use with a Behavior; defining the Behavior for the defined user interface element; defining a user interface class for the defined Behavior; registering the defined Behavior with the user interface application; and defining a trigger event within the defined user interface class to activate when a particular event is detected by the Behavior.

The foregoing and other described implementations can each, optionally, include one or more of the following features:

A first feature, combinable with any of the following features, wherein the defined UI class includes an event handler for detecting the particular event.

A second feature, combinable with any of the previous or following features, further comprising one or more instructions to trigger the trigger event upon detection of the particular event.

A third feature, combinable with any of the previous or following features, wherein the event handler is defined for the defined user interface class based upon a particular Context that the particular event will be bound to at runtime.

A fourth feature, combinable with any of the previous or following features, further comprising, at runtime, one or more instructions to place the defined Behavior within a particular Context.

A fifth feature, combinable with any of the previous or following features, wherein registering the Behavior with the user interface application further comprises passing the defined user interface class to a register function.

A sixth feature, combinable with any of the previous or following features, further comprising, at runtime, one or more instructions to test the Behavior in the user interface application.

In a third implementation, a computer-implemented system, comprising: a computer memory; and a hardware processor interoperably coupled with the computer memory and configured to perform operations comprising: at design-time: defining a user interface element of a user interface application for use with a Behavior; defining the Behavior for the defined user interface element; defining a user interface class for the defined Behavior; registering the defined Behavior with the user interface application; and defining a trigger event within the defined user interface class to activate when a particular event is detected by the Behavior.

The foregoing and other described implementations can each, optionally, include one or more of the following features:

A first feature, combinable with any of the following features, wherein the defined UI class includes an event handler for detecting the particular event.

A second feature, combinable with any of the previous or following features, further configured to trigger the trigger event upon detection of the particular event.

A third feature, combinable with any of the previous or following features, wherein the event handler is defined for the defined user interface class based upon a particular Context that the particular event will be bound to at runtime.

A fourth feature, combinable with any of the previous or following features, further configured, at runtime, to place the defined Behavior within a particular Context.

A fifth feature, combinable with any of the previous or following features, wherein registering the Behavior with the user interface application further comprises passing the defined user interface class to a register function.

A sixth feature, combinable with any of the previous or following features, further configured, at runtime, to test the Behavior in the user interface application.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., or less than 5 secs. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory may store various objects or data, including caches, classes, frameworks, applications, modules, backup data, jobs, web pages, web page templates, data structures, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
at design-time, by operation of a computer:
defining a user interface element of a user interface application for use with a Behavior;
defining the Behavior for the defined user interface element;
defining a user interface class for the defined Behavior;
registering the defined Behavior with the user interface application; and
defining a trigger event within the defined user interface class to activate when a particular event is detected by the Behavior.

2. The computer-implemented method of claim 1, wherein the defined user interface class includes an event handler for detecting the particular event.

3. The computer-implemented method of claim 2, further comprising triggering the trigger event upon detection of the particular event.

4. The computer-implemented method of claim 2, wherein the event handler is defined for the defined UI class based upon a particular Context that the particular event will be bound to at runtime.

5. The computer-implemented method of claim 1, further comprising, at runtime, placing the defined Behavior within a particular Context.

6. The computer-implemented method of claim 1, wherein registering the Behavior with the user interface application further comprises passing the defined user interface class to a register function.

7. The computer-implemented method of claim 1, further comprising, at runtime, testing the Behavior in the user interface application.

8. A non-transitory, computer-readable medium storing one or more instructions executable by a computer system to perform operations comprising:
at design-time:
defining a user interface element of a user interface application for use with a Behavior;
defining the Behavior for the defined user interface element;
defining a user interface class for the defined Behavior;
registering the defined Behavior with the user interface application; and
defining a trigger event within the defined user interface class to activate when a particular event is detected by the Behavior.

9. The non-transitory, computer-readable medium of claim 8, wherein the defined user interface class includes an event handler for detecting the particular event.

10. The non-transitory, computer-readable medium of claim 9, further comprising one or more instructions to trigger the trigger event upon detection of the particular event.

11. The non-transitory, computer-readable medium of claim 9, wherein the event handler is defined for the defined UI class based upon a particular Context that the particular event will be bound to at runtime.

12. The non-transitory, computer-readable medium of claim 8, further comprising, at runtime, one or more instructions to place the defined Behavior within a particular Context.

13. The non-transitory, computer-readable medium of claim 8, wherein registering the Behavior with the user interface application further comprises passing the defined user interface class to a register function.

14. The non-transitory, computer-readable medium of claim 8, further comprising, at runtime, one or more instructions to test the Behavior in the user interface application.

15. A computer-implemented system, comprising:
a computer memory; and
a hardware processor interoperably coupled with the computer memory and configured to perform operations comprising:
at design-time:
defining a user interface element of a user interface application for use with a Behavior;
defining the Behavior for the defined user interface element;
defining a user interface class for the defined Behavior;
registering the defined Behavior with the user interface application; and
defining a trigger event within the defined user interface class to activate when a particular event is detected by the Behavior.

16. The computer-implemented system of claim 15, wherein the defined user interface class includes an event handler for detecting the particular event, and wherein the event handler is defined for the defined user interface class based upon a particular Context that the particular event will be bound to at runtime

17. The computer-implemented system of claim 16, further configured to trigger the trigger event upon detection of the particular event.

18. The computer-implemented system of claim 15, further configured, at runtime, to place the defined Behavior within a particular Context.

19. The computer-implemented system of claim 15, wherein registering the Behavior with the user interface application further comprises passing the defined user interface class to a register function.

20. The computer-implemented system of claim 15, further configured, at runtime, to test the Behavior in the user interface application.
